(19) United States
(12) Patent Application Publication
(10) Pub. No.: US 2012/0120242 A1
(43) Pub. Date: May 17, 2012

(54) SECURITY-ENHANCED CCTV SYSTEM

(76) Inventors: Soon Gyung CHOI, Gyeonggi-do (KR); Kyung Sug Lee, Seoul (KR)

(21) Appl. No.: 13/152,755

(22) Filed: Jun. 3, 2011

(30) Foreign Application Priority Data
Nov. 3, 2010 (KR) 10-2010-0108611

(51) Int. Cl. H04N 7/18

(52) U.S. Cl. 348/159; 348/E07.085

(57) ABSTRACT

Disclosed herein is a security-enhanced CCTV system. The security-enhanced Closed-Circuit Television (CCTV) system includes a plurality of CCTV cameras installed at locations desired to be captured. An image processing device is installed outside an Operations Room (OR) so as to control the CCTV cameras and to store and output captured images. A resource distributor is installed inside the operations room, with the resource distributor being connected to the image processing device in a wired or wireless manner, and is configured to receive stored images from the image processing device or mutually communicate control signals required to control the CCTV cameras with the image processing device. An input/output device outputs the control signals for the CCTV cameras or displays the captured images through the resource distributor.

### BACKGROUND OF THE INVENTION

1. Field of the Invention

The present invention relates, in general, to a security-enhanced Closed-Circuit Television (CCTV) system, and, more particularly, to a CCTV system, which is configured such that an image processing device for storing captured images is located outside an operations room in which CCTV cameras are controlled, so that the image processing device can be prevented from being stolen or damaged even in the case of illegal entry, thus further enhancing a security function.

2. Description of the Related Art

A CCTV system is a TV system for transmitting images to specific recipients. The range of the application of such a CCTV system extends to various fields such as industry, education, medical services, monitoring for traffic control, prevention against disasters, and the transmission of video information in a company.

Such a CCTV system includes CCTV cameras installed to capture specific areas, an imaging device for storing captured images and outputting the images to the outside of the imaging device if necessary, and an input/output device for controlling the CCTV cameras and displaying the captured images on a screen. Here, the input/output device typically includes a screen display means such as a monitor, and an I/O means such as a keyboard for controlling the CCTV cameras.

However, such a conventional CCTV system has the following problems.

1) Since the imaging device which actually stores the captured images is installed inside the operations room in which CCTV cameras are controlled, the imaging device may be lost when intruders enter and leave the operations room. The loss of the imaging device may result in the loss of image data that can be utilized as important evidence of incidents captured by CCTVs.

2) The loss of the imaging device may cause an operational vacuum in the CCTV system in the period before a new imaging device is installed after the existing imaging device disappeared. Therefore, there is a concern that due to such an operational vacuum, fires or other crimes could easily occur.

### SUMMARY OF THE INVENTION

Accordingly, the present invention has been made keeping in mind the above problems occurring in the prior art, and an object of the present invention is to provide a security-enhanced CCTV system, in which an image processing device is installed outside an operations room, so that the image processing device is prevented from being lost or damaged even if intruders gain access to the operations room, thus further enhancing security and safety.

Another object of the present invention is to provide a security-enhanced CCTV system, which can directly receive captured images output from the image processing device using a resource distributor if necessary, thus enabling required images to be easily and conveniently received and used.

In order to accomplish the above objects, the present invention provides a security-enhanced Closed-Circuit Television (CCTV) system, including a plurality of CCTV cameras installed at locations desired to be captured; an image processing device installed outside an operations room so as to control the CCTV cameras and to store and output captured images; a resource distributor installed inside the operations room, with the resource distributor being connected to the image processing device in a wired or wireless manner, and configured to receive stored images from the image processing device or mutually communicate control signals required to control the CCTV cameras with the image processing device; and an input/output device for outputting the control signals for the CCTV cameras or displaying the captured images through the resource distributor.

Preferably, the image processing device may be one of a Video Cassette Recorder (VCR), a Digital Video Recorder (DVR), and a High Definition Video (HDV) recorder. Further, the image processing device may include a transmission unit so that the image processing device is connected to the resource distributor, wherein the transmission unit includes an image processing unit for mixing and processing images output from the CCTV cameras, and outputting the processed images to the resource distributor; and an external Input/Output (I/O) port for outputting the processed images to an outside of the image processing device or receiving external commands from the outside. In this case, the external I/O port may be a Universal Serial Bus (USB) port.

Preferably, the resource distributor may include an image processing unit for outputting images received from the image processing device to the input/output device; and an external I/O port for outputting the received images to an outside of the resource distributor or enabling input means for auxiliary control to be connected thereto. In this case, the external I/O port may be a USB port.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing the overall construction of a CCTV system according to a first embodiment of the present invention;

FIG. 2 is a diagram showing the construction of the transmission unit of an image processing device and a resource distributor according to the present invention; and

FIG. 3 is a block diagram schematically showing the overall construction of the CCTV system according to a second embodiment of the present invention.

### DESCRIPTION OF THE PREFERRED EMBODIMENTS

Hereinafter, embodiments of the present invention will be described in detail with reference to the attached drawings. Prior to giving the description, the terms and words used in the present specification and claims should not be interpreted as being limited to their typical meaning based on the dictionary definitions thereof, but should be interpreted to have the meaning and concept relevant to the technical spirit of the present invention on the basis of the principle by which the inventor can suitably define the implications of terms in the way which best describes the invention.

Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

### First Embodiment

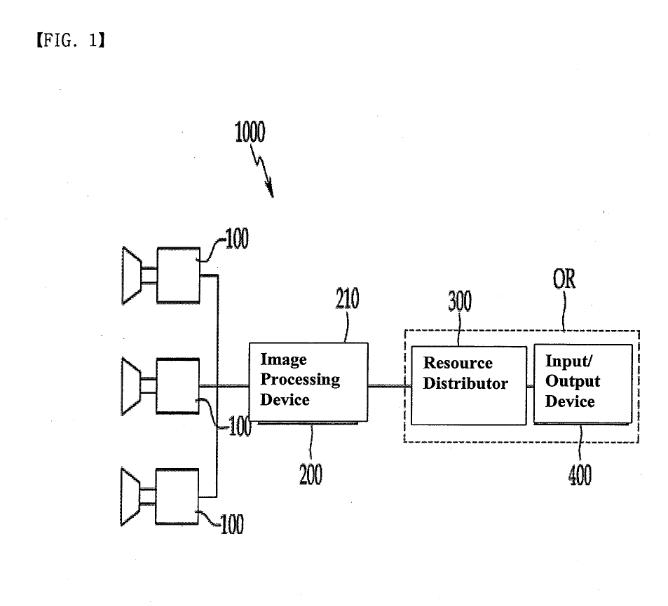

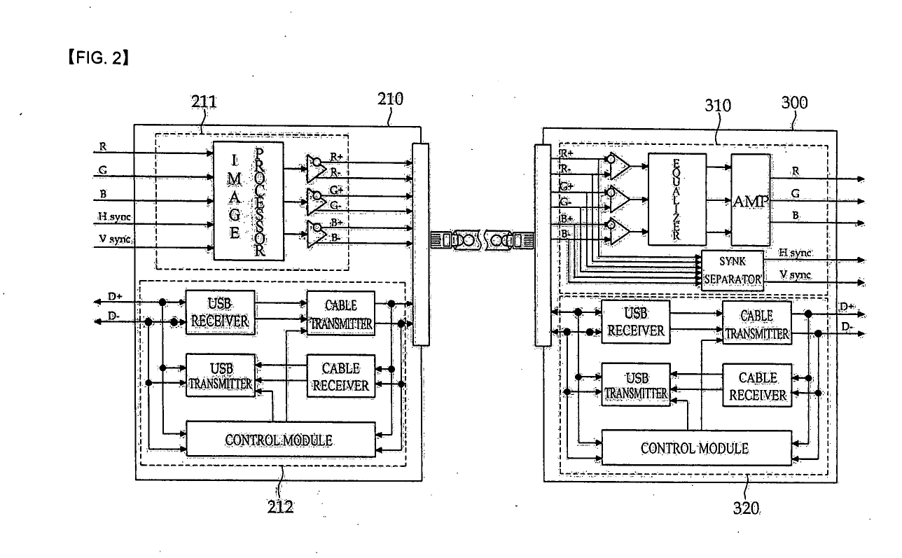

FIG. 1 is a block diagram schematically showing the overall construction of a CCTV system according to a first embodiment of the present invention, and FIG. 2 is a diagram showing the construction of the transmission unit of an image processing device and a resource distributor according to the present invention.

A CCTV system 100 according to a first embodiment of the present invention includes a plurality of CCTV cameras 100, an image processing device 200, a resource distributor 300, and an input/output device 400. The CCTV cameras 100 are installed in places requiring image capturing. The image processing device 200 stores and retains the captured images and outputs the images to the outside of the image processing device if necessary. The resource distributor 300 provides the images output from the image processing device 200 to the outside of the resource distributor 300 or to the input/output device 400. Further, the input/output device 400 displays the provided images on a screen, and receives control signals for the CCTV cameras 100.

Hereinafter, individual components of the above construction will be described in detail.

The CCTV cameras 100 are installed in places requiring image capturing, and if necessary, a plurality of CCTV cameras may be installed. Each CCTV camera 100 is implemented as a camera that can be used in the nighttime as well as in the daytime. Further, a network camera that uses a web-based network, as well as normal CCTV cameras, can be used as the CCTV camera 100.

The image processing device 200 mixes images transmitted from the CCTV cameras 100, stores the mixed images, and then outputs the mixed images to the input/output device 400, which will be described later. A digital video storage device (Digital Video Recorder: DVR) that is typically and frequently used may be used as such an image processing device. Since a DVR stores images using a Hard Disk Drive (HDD), a Digital Video disk (DVD), etc., it is easy to play images on or search images using the screen. Further, since the images are stored as digital signals, it is convenient to edit and transmit the images. Furthermore, the DVR has various selection menu functions such as a motion search function, a recording function in connection with sensors, position control functions for cameras (auto pan/tilt/zoom/control), and image magnification and editing functions. Further, the DVR can search for images for respective cameras or events, as well as for respective times or dates, can perform monitoring in real time even from a remote place, and can also perform searching, backup and camera control.

Further, the image processing device 200 may be implemented as a Video Cassette Recorder (VCR) which uses typical inexpensive video cassettes as storage media, or a High Definition Video (HDV) recorder which enables face images to be recognized and has recently been developed. In particular, the HDV recorder enabling face recognition has been widely used to provide security in police stations, airports, etc., because captured real-time images and the faces of specific persons can be compared by searching a database (DB).

Meanwhile, the image processing device 200 includes a transmission unit 210 for outputting the captured images to the input/output device 400. The transmission unit 210 includes an image processing unit 211 for mixing and processing images transmitted from the CCTV cameras 100 so that the images can be stored, and an external Input/Output (I/O) port 212 for outputting the processed images to the outside of the image processing device 200 or receiving control commands from the outside.

The image processing unit 211 may be implemented as a color signal mixer typically provided in the above-described DVR or HDV recorder. Mixed images are either transmitted to the resource distributor 300 or provided to the outside of the image processing device via the external I/O port 212.

The external I/O port 212, which is a kind of communication port, is used as a data transmission port or used to enable a separate input device to be connected thereto so as to receive control signals. Such an external I/O port 212 is preferably implemented as a Universal Serial Bus (USB) port that can be easily mounted and used.

The image processing device 200 implemented in this way is installed outside the operations room (OR), rather than inside the operations room. Here, the operations room (OR) refers to a control room in which the resource distributor 300 and the input/output device 400 which will be described later are installed, and in which an operator controls the CCTV cameras 100 using the input/output device 400 if necessary while viewing the images output from the CCTV cameras 100.

In this way, the reason for installing the image processing device 200 in a location other than the operations room (OR) in the present invention is to prevent the image processing device 200 from being easily damaged or stolen even if intruders gain access to the operations room from the outside for the purpose of stealing.

The resource distributor 300 is installed inside the operations room (OR) and configured to communicate with the image processing device 200 in a wired manner. Such a resource distributor 300 includes an image processing unit 310 for outputting images received from the image processing device 200 to the input/output device 400, and an external I/O port 320 for enabling the images to be provided to the outside of the resource distributor 300.

In this case, the image processing unit 310 may be configured to have the same construction as the image processing unit 211 of the image processing device 200. However, the image processing unit 310 uses a processor capable of processing images so that the images actually processed by the image processing unit 310 can be directly viewed on a display screen such as the monitor of the input/output device 400, which will be described later.

Further, the external I/O port 320 is the same as that of the image processing device 200. Such an external I/O port 320 enables a storage device such as a hard disk or a Digital Versatile Disk (DVD) to be connected thereto, and is then used to directly download required images from the image processing device 200 to the storage device, or to download data or image information, which is stored in or is output from the input/output device 400, to the storage device. Further, the external I/O port 320 may be connected to an input means such as a keyboard or a mouse, and may be used as an auxiliary control means which is an auxiliary means for controlling the CCTV system without using the input/output device 400.

The input/output device 400 includes a display screen such as the monitor for displaying images, and an input means having a keyboard and a mouse for inputting control signals. Such an input/output device 400 is installed inside the operations room (OR) just as the resource distributor 300 is.

Further, the input/output device 400 outputs and displays required captured images on the display screen, or receives control signals, such as position control signals for the CCTV cameras 100, using the input means.

In the CCTV system having the above construction according to the first embodiment of the present invention, the image processing device 200 and the resource distributor 300 are connected to each other in a wired manner after the image processing device 200 has been concealed outside the operations room (OR), rather than inside the operations room (OR), thus transmitting or receiving required images and control signals required for control using mutual communication.

### Second Embodiment

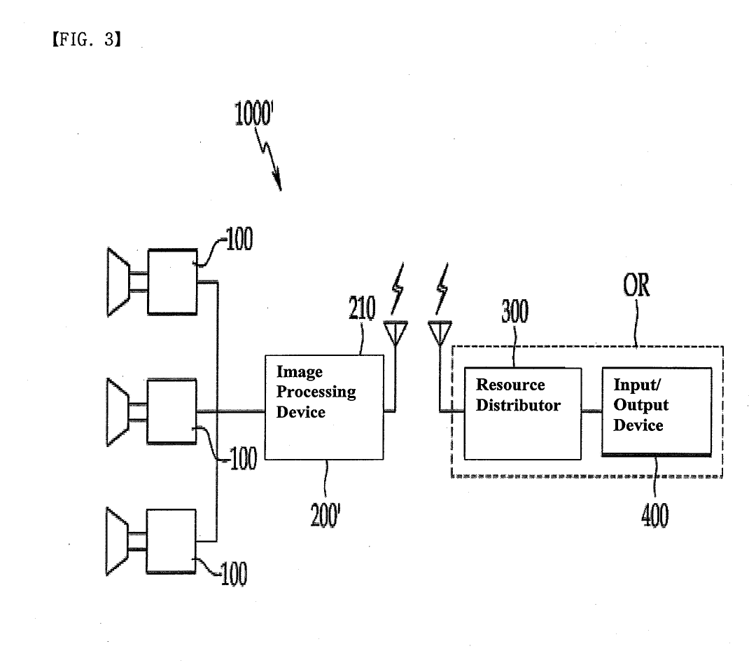

FIG. 3 is a block diagram schematically showing the overall construction of a CCTV system according to a second embodiment of the present invention. In this case, the same reference numerals are used to designate components identical to those of the first embodiment, and a detailed description thereof is omitted.

A CCTV system 1000′ according to the second embodiment of the present invention is different from the first embodiment in a communication method between the image processing device 200 and the resource distributor 300.

That is, in the CCTV system 1000′ according to the second embodiment of the present invention, communication is performed between an image processing device 200′ and a resource distributor 300′ in a wireless manner.

In this case, the image processing device 200′ and the resource distributor 300′ communicate with each other using short-range wireless communication methods. Further, short-range wireless communication methods may include, for example, Zigbee, Wireless Local Area Network (WLAN), Wireless Personal Area Network (WPAN), Bluetooth, Ultra-Wideband, and binary Code Division Multiple Access (CDMA) communication methods.

As described above, the present invention is configured such that the image processing device is installed outside the operations room, and data communication is performed in a wired or wireless manner between the image processing device and a resource distributor installed inside the operations room. Accordingly, there is an advantage in that the image processing device can be prevented from being stolen or damaged, thus further enhancing a security function.

Accordingly, the security-enhanced CCTV system according to the present invention has the following advantages.

1) Since an image processing device can be concealed from view in a place outside an operations room, rather than inside an operations room, the image processing device can be prevented from being damaged or stolen even if intruders gain access to the operations room. This makes it possible to protect captured images, thus further enhancing security and safety.

2) Images stored in the image processing device can be provided to the outside thereof via the external I/O port of a resource distributor if necessary, thus improving convenience.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A security-enhanced Closed-Circuit Television (CCTV) system, comprising:
a plurality of CCTV cameras installed at locations desired to be captured;
an image processing device installed outside an operations room so as to control the CCTV cameras and to store and output captured images;
a resource distributor installed inside the operations room, with the resource distributor being connected to the image processing device in a wired or wireless manner, and configured to receive stored images from the image processing device or mutually communicate control signals required to control the CCTV cameras with the image processing device; and
an input/output device for outputting the control signals for the CCTV cameras or displaying the captured images through the resource distributor.

2. The security-enhanced CCTV system according to claim 1, wherein the image processing device comprises a transmission unit so that the image processing device is connected to the resource distributor, the transmission unit comprising:
an image processing unit for mixing and processing images output from the CCTV cameras, and outputting the processed images to the resource distributor; and
an external Input/Output (I/O) port for outputting the processed images to an outside of the image processing device or receiving external commands from the outside.

3. The security-enhanced CCTV system according to claim 1, wherein the image processing device is one of a Video Cassette Recorder (VCR), a Digital Video Recorder (DVR), and a High Definition Video (HDV) recorder.

4. The security-enhanced CCTV system according to claim 3, wherein the external I/O port is a Universal Serial Bus (USB) port.

5. The security-enhanced CCTV system according to claim 1, wherein the resource distributor comprises:
an image processing unit for outputting images received from the image processing device to the input/output device; and
an external I/O port for outputting the received images to an outside of the resource distributor or enabling input means for auxiliary control to be connected thereto.

6. The security-enhanced CCTV system according to claim 5, wherein the external I/O port is a USB port.

7. The security-enhanced CCTV system according to claim 2, wherein the image processing device is one of a Video Cassette Recorder (VCR), a Digital Video Recorder (DVR), and a High Definition Video (HDV) recorder.

8. The security-enhanced CCTV system according to claim 7, wherein the external I/O port is a Universal Serial Bus (USB) port.
